(19) United States
(12) Patent Application Publication
(10) Pub. No.: US 2025/0047954 A1
(43) Pub. Date: Feb. 6, 2025

(54) SYSTEMS AND METHODS FOR PERSONALIZED GAME COMMENTARY STREAMS

(71) Applicant: Sony Interactive Entertainment Inc., Tokyo (JP)

(72) Inventors: Michael Taylor, San Mateo, CA (US); Coimbatore Ravi Madhavan, Sunnyvale, CA (US); Richard Olabode, Foster City, CA (US)

(73) Assignee: Sony Interactive Entertainment Inc., Tokyo (JP)

(21) Appl. No.: 18/363,700

(22) Filed: Aug. 1, 2023

(51) Int. Cl. H04N 21/81; A63F 13/86; H04N 21/233; H04N 21/239

(52) U.S. Cl. CPC H04N 21/8106; A63F 13/86; H04N 21/233; H04N 21/2393

(57) ABSTRACT

System, process and device configurations are provided for generating game commentary streams. Game commentary streams can include gameplay video data with voice data of multiplayer game users synchronized to one or more game events and game states in recorded gameplay. Game commentary streams may allow for selection of game play content from the perspective of a selected user and to obtain voice data of the user and one or more other users during the game session. Methods for generating a commentary stream can include receiving game commentary data from users of a multiplayer electronic game including voice data detected during the game session and generating the commentary stream to include gameplay data for the game session and selected game commentary data. User requests may be received and the commentary stream may be output for recorded game play from the perspective of one or more users of the game session.

### FIELD

The present disclosure is directed to interactive entertainment and electronic video gaming, including gaming device operations, processes, configurations, user interface control and control device configurations.

### BACKGROUND

Computer and console games offer players different types of gaming experiences. In recent years there has been increased interest in viewing of electronic gameplay. Playback of recorded gameplay for a single user may only provide a limited view of a gameplay session. There is a desire for processes and devices to improve viewing of electronic gameplay. There is also a desire to provide content in addition to gameplay video. There is also a desire to provide context information with electronic playback of game content. Accordingly, there is a need and a desire for game systems and devices to process gaming data for electronic gameplay.

### BRIEF SUMMARY OF THE EMBODIMENTS

Disclosed and described herein are systems, methods and configurations for generating a personalized game commentary stream. In one embodiment, a method includes receiving, by a device, game commentary data from at least one user of a multiplayer electronic game for a game session, wherein the game commentary data includes voice data of the at least one user detected during the game session. The method also includes generating, by the device, a commentary stream for the game session, wherein the commentary stream is generated to include gameplay data for the game session and selected game commentary data from the at least one user. The method also includes receiving, by the device, a user request for the commentary stream, wherein the request identifies a first user of the game session. The method also includes outputting, by the device, the commentary stream for the game session.

In one embodiment, receiving the commentary from the at least one user of the multiplayer game for a game session includes receiving voice data from a plurality of users of the game session and game data for at least one game state of the game session.

In one embodiment, receiving game commentary includes receiving video data of at least one user reaction of the at least one user during the game session. (User camera perspective)

In one embodiment, generating the commentary stream includes selecting voice data from the at least one user for a game state of the game session, and generating an audio track based on selections of voice data for the game session.

In one embodiment, generating the commentary stream includes selecting voice data from at least one additional user and splicing received voice data for the at least one user and the at least one additional user to generate a commentary stream audio track for the at least one user.

In one embodiment, generating the commentary stream includes selecting voice data to generate an audio track for based on at least one event in the game session. (player actions)

In one embodiment, receiving the user request includes receiving a request for recorded game play from the perspective of the first user of the game session and voice data of the first user during the game session.

In one embodiment, outputting the commentary stream includes output of commentary stream with recorded gameplay video of the game session, wherein output of the commentary stream includes at least one of user audio and video data.

In one embodiment, outputting the commentary stream includes output of audio and video data associated with the first user.

In one embodiment, the method includes receiving a user input for selection of a second user, and outputting the commentary stream to include output of audio and video data associated with the second user.

Another embodiment is directed to a device configured for generating a personalized game commentary stream. The device includes an interface, memory storing executable instructions, and a controller coupled to the interface and memory. The controller is configured to receive game commentary data from at least one user of a multiplayer electronic game for a game session, wherein the game commentary data includes voice data of the at least one user detected during the game session. The controller is also configured to generate a commentary stream for the game session, wherein the commentary stream is generated to include gameplay data for the game session and selected game commentary data from the at least one user. The controller is also configured to receive a user request for the commentary stream, wherein the request identifies a first user of the game session. The controller is also configured to output the commentary stream for the game session.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is a graphical representation of a system according to one or more embodiments;

FIG. 2 illustrates a process for generating personalized game commentary according to one or more embodiments;

FIG. 3 illustrates a device configuration according to one or more embodiments; and

FIG. 4 illustrates a graphical representation of a process for generating a personalized game commentary stream according to one or more embodiments.

### DETAILED DESCRIPTION OF THE EXEMPLARY EMBODIMENTS

### Overview and Terminology

One aspect of the disclosure is directed to generating game commentary streams. A system, process and device configurations are provided for generating game commentary streams to include gameplay video data with game commentary data of one or more multiplayer game users. According to embodiments, game commentary data which may include user voice, video data of a user (e.g., user reactions, expressions, etc.) and data detected from a game chat may be synchronized into to one or more game events and game states in recorded gameplay. Game commentary streams may allow for selection of game play content from the perspective of a selected user and to obtain voice data of the user and one or more other users during the game session. Methods for generating a commentary stream can include receiving game commentary data from users of a multiplayer electronic game including voice data detected during the game session and generating the commentary stream to include gameplay data for the game session and selected game commentary data. User requests may be received and the commentary stream may be output for recorded game play from the perspective of one or more users of the game session.

Embodiments are directed to systems, devices and methods for game operations and controls, including operations for generating game commentary, analyzing gaming content and control of presentation of game play. Gaming systems may include consoles that play game media, consoles that provide network data for games, handheld devices, mobile devices (e.g., tablets, mobile phones, etc.) and devices in general configured for electronic gaming.

According to embodiments, generating a commentary stream includes generating personalized commentary from at least one single game state for games having one or more players (e.g., users). According to embodiments, a control device such as a game console, server, etc., may be configured to receive game commentary from at least one user and generate a commentary stream for a game session. For a single user, game commentary detected may be synchronized to one or more game states. The game commentary stream may be presented or played back to include game play video data and user game commentary. The game commentary stream may include one or more of user voice, user video data and game commentary in general detected during the game play. Game commentary streams can be generated for a plurality of players, such as for a multiplayer game including game commentary for a plurality of players and game play data for the plurality of players. Generating the commentary stream for a multiplayer game can include receiving game commentary data from at least one or the players, and generating a commentary stream to include commentary from multiple players. By way of example, the commentary stream could be generated to include game play video data from at least one player perspective with commentary spliced into the stream.

According to embodiments, game commentary streams may be generated based on a game title and/or game title type. In cooperative and competitive gameplay sessions, processes are provided for generating custom commentary tracks focused on individual players actions over the course of the session. By way of example, commentary stream may include gameplay video for a first player with commentary from one or more other players of a game session based on a game state. The commentary stream may also include game video for one or more player views. The commentary stream may be generated and saved for presentation to one or more viewers for selection of one or more other choose between the commentary streams. Presentation of the commentary stream can include splicing tracks to allow for selection and/or presentation of game video content based on a selected player and for selection and switching to another player.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

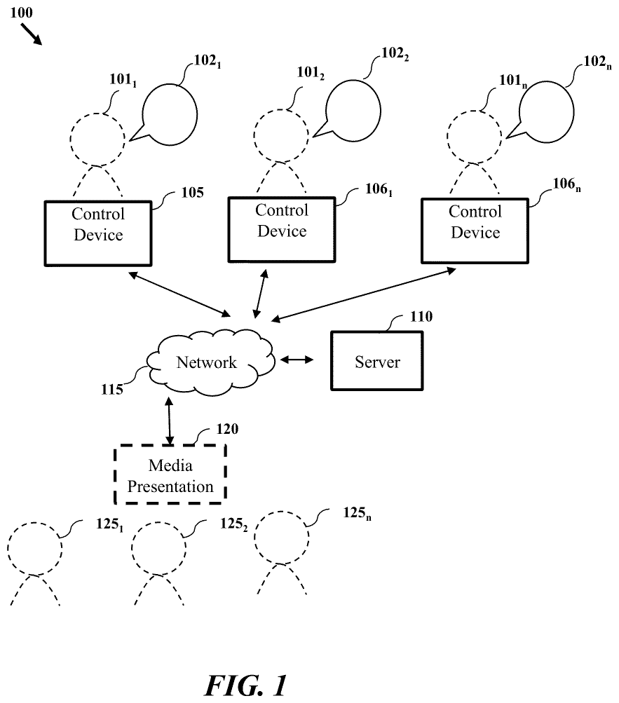

FIG. 1 is a graphical representation of a system according to one or more embodiments. System 100 may be configured to generate one or more personalized game commentary streams. According to embodiments, system 100 includes control device 105 which may be configured to communicate with server 110 by way of network 115.

According to embodiments, generating a personalized commentary stream may include a device, such as control device 105 and/or server 110, receiving game commentary data from at least one user of an electronic game, such as a single player game and a multiplayer game. Operations for generating the personalized commentary stream for single player or multiplayer games may be performed by a device outputting gameplay, such as control device 105 or a game console. According to other embodiments, the game commentary stream may be generated by a network device, such as server 110 or one or more network devices (e.g., processors, controllers, host devices, etc.) associated with server 100. It should be appreciated that operations performed by server 110 may be performed by one or more devices of system 100. According to embodiments, processes performed by devices of system 100, may be performed by devices such as a gaming console, handheld gaming device, computer, tablet, mobile phone, etc. System 100 may be controlled to initiate generating a game commentary stream when a gaming session is initiated.

Control device 105 may be configured to provide game content to one or more users, such as user 1011. According to embodiments, control device 105 may be configured to generate a personalized game commentary stream. System 100 may include one or more additional control devices, such as control devices 1061-n. Control device 105 and control devices 1061-n may each be configured to present an electronic game and receive user input. According to embodiments, control device 105 and control devices 1061-n may each be configured to receive game commentary data, such as game commentary data 1021-n. One or more devices of system 100 may be configured to perform processes described herein.

According to embodiments, one or more devices of system 100, such as control device 105 and control devices 1061-n, may be configured to detect and/or receive commentary data from one or more players of a game. Commentary data 1021-n may include one or more of voice data for a player, camera (e.g., video, image, etc.) of a user, and user generated data, such as a game chat data for a game session. Control device 105 and control devices 1061-n may each include one or more sensors and/or input devices, such as a microphone, headset, camera, controller and user interface to detect player commentary data.

Control device 105 may be configured to provide gaming data for user 1011 and to detect and/or receive commentary data 1021 from user 1011. Similarly, control devices 1061-n may be configured to provide gaming data for users 1012-n and configured to detect and/or receive commentary data 1022-n from users 1012-n. Control device 105 and control devices 1061-n may be configured to provide commentary data relative to each other by way of network 115 and to server 110. Based on received commentary data, server 110 may be configured to generate a commentary stream. Server 110 may be configured to output the commentary stream to control device 105 and control devices 1061-n. According to embodiments, server 110 may be configured to output the commentary stream to one or more devices for presentation. By way of example, control device 105 may output the commentary stream to user 1011 or a display device associated with control device 105. According to other embodiments, server 110 may output the commentary stream to media presentation device (e.g., display, media device, etc.) for presentation to viewers 1251-n. One or more of server 110, control device 105 and control devices 1061-n may receive user requests for presentation of a commentary stream including selection of a user. Accordingly, output of a commentary stream may be based on a selected player, such as selection of player 1011 for presentation of the commentary stream.

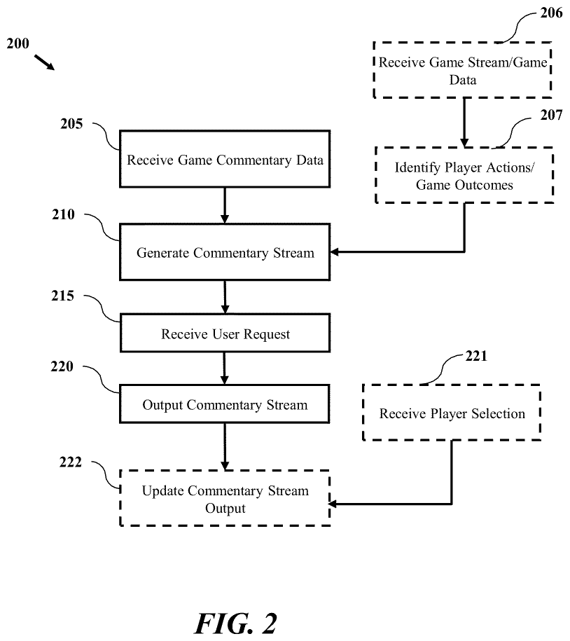

According to embodiments, devices of system 100 may be configured to perform one or more processes described herein, including process 200 of FIG. 2 for generating a commentary stream. Processes performed by system 100 may include presenting a commentary stream to one or more viewers, such as viewers 1251-n by way of media presentation device 120. Media presentation device 120 may be configured to provide a user interface to select one or more users, such as players 1011-n, such that the game commentary stream may be output based on a selected player. Media presentation device 120 may be a display, media player, handheld device, etc. configured to output audio and video data of the game commentary stream.

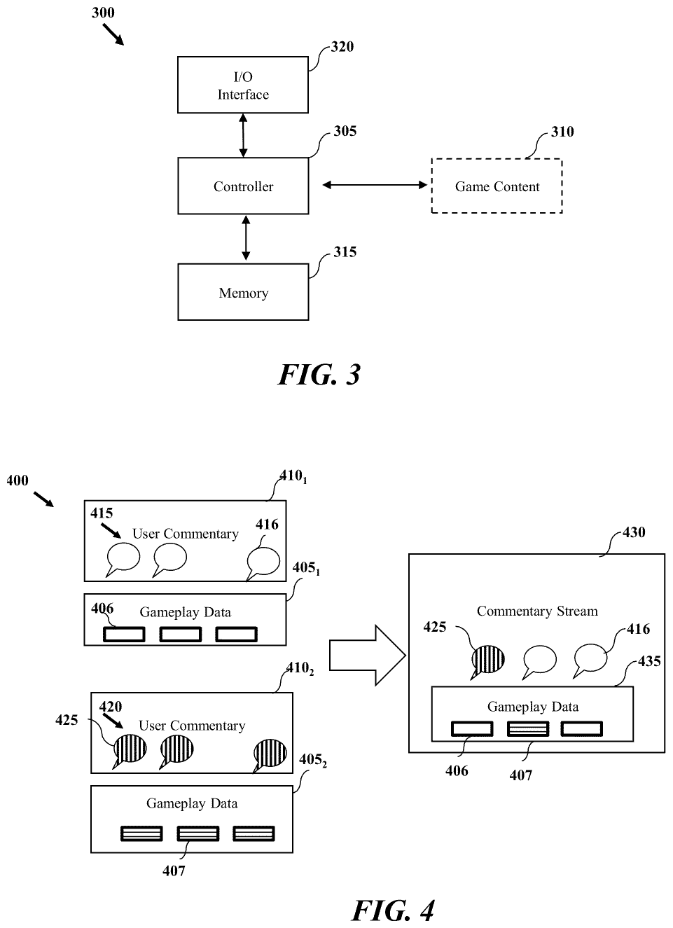

FIG. 2 illustrates a process for generating personalized game commentary according to one or more embodiments. Process 200 may generate game commentary for one or more game sessions including game commentary selected based on one or more of events and outcomes in a game session. Process 200 may be performed by a device, such as control device 105 or server 110 of FIG. 1 and/or controller 305 of FIG. 3.

Process 200 may be initiated by a device receiving game commentary data at block 205. According to embodiments, a device may receive game commentary data from at least one user of a multiplayer electronic game for a game session. The game commentary data may be detected by a device during the game session and communicated from the sensing device, such as a headset, console and/or peripheral to a network device, such as a server. Game commentary data may be received from multiple devices associated with players at block 205. For example, for a multiplayer game with players in different locations, the game commentary data may be separately transmitted by way of the network. According to embodiments, game commentary data includes voice data of the at least one user detected during the game session. Game commentary can include video data of a user, such as user reactions, and other player provided data, such as player chat data. Receiving the commentary from the at least one user of the multiplayer game for a game session at block 205 can include receiving video data of at least one user reaction of the at least one user during the game session. Video data of a player may be relevant to provide a user perspective. Receiving the commentary from the at least one user of the multiplayer game for a game session at block 205 can include receiving voice data from a plurality of users of the game session and game data for at least one game state of the game session. Process 200 optionally includes receiving a game stream/game data at block 206 which may include one or more of a game vector and game engine data for one or more players of the game. Process 200 can also optionally include identifying player actions and/or game outcomes at block 207.

According to embodiments, process 200 is configured to allow for control and presentation of electronic gaming content, such as content associated with a multiplayer game. In addition, embodiments are directed to generating game commentary based on data for one or more players, including player data. It should be appreciated that operations and processes for collection of player or user data, including user voice and user audio, may be based on expressed consent of a user. Users may be notified of operations and collection of user data. Operations may also require adult confirmation and user agreement for operations to be performed on a console or a device. Process 200 and operations described herein may provide features to improve user experience, wherein functions and operations described herein are performed following user consent, with express notice to a user, and/or in alignment with one or more user settings for user privacy. It should be appreciated that embodiments may be applied to interactive entertainment with one or more users. Processes described herein are not limited to gaming content.

According to embodiments, generating a game commentary stream can include recording gameplay data and/or receiving recorded gameplay data for at least one user during a game session. Recorded gameplay can be video data of a game session from the perspective of each user of the game session. Recorded game play may be data characterizing a game session that may be used to generate video data for the session. Recorded game play can also include data for user actions during the game session with respect to control commands. Receiving game commentary data can include receiving timing information, such as a time stamp, of the game commentary data. Game commentary for one or more of voice or spoken commentary, video reactions, camera data, a webcam view, and text or symbols during a game chat may be collected with timing information.

At block 210, process 200 can include generating a commentary stream for a game session. According to embodiments, the commentary stream is generated to include gameplay data for the game session and selected game commentary data from the at least one user. Generating the commentary stream can include selecting voice data from the at least one user for a game state of the game session, and generating an audio track based on selections of voice data for the game session. According to embodiments, generating the commentary stream includes selecting voice data from at least one additional user and splicing received voice data for the at least one user and the at least one additional user to generate a commentary stream audio track. A commentary stream can be generated for game commentary data or for a combination of game commentary and gameplay video data. According to embodiments, generating the commentary stream includes generating a track or storyline from the perspective of each player of a game. One or more game events are identified and game commentary is selected based on the event to generate the commentary stream. Accordingly, generating a commentary stream can include selecting voice data to generate an audio track for based on at least one event in the game session based on player actions.

According to embodiments, generating a commentary stream includes creating at least one story line of a game session, wherein a storyline may include gameplay from the perspective of each player. For example, a first player enters a game, the first player achieves a game goal, and the first player then advances to a next level. According to embodiments, a storyline may be created for the game session. For example, the storyline may include a first player entering the session, a second player completing a task, a third player advancing to a next level, and the first player advancing to the next level. According to embodiments, player reactions and commentary may be captured, selected, and incorporated into a commentary stream. The commentary stream may be generated following a gameplay session and/or as the gameplay session unfolds. In embodiments, the commentary stream may be generated to provide a video stream or post game recording where player commentary can be viewed. In embodiments, the game commentary stream may be an interactive file or data record, such that user selections may be received for selection a game view or commentary track and for control of game commentary presentation.

According to embodiments, generating a commentary stream includes identification of commentary data that aligns with events in a gameplay session. Process 200 may include performing a gameplay analysis to identify events and the context of events in a gameplay session. By way of example, gameplay data that includes graphical elements switching to an action sequence may be identified or labeled. Key emotions in gameplay that lead up to an event may also be identified. Emotional context of events may be identified based on the gameplay data and commentary. Live commentary may be analyzed to determine comments that support characterizations of events. According to embodiments, analysis of events may include generating a causal graph or timeline of events that include main events and that provide a build-up of causal relationships.

The commentary stream generated at block 210 may be based on a game stream and game data received at optional block 206. Similarly, the commentary stream generated at block 210 may be based on player actions identified/game outcomes at optional block 207. According to embodiments, a game commentary stream may include one or more multiplayer action windows that presented from one or more views, such as player display window or tile of player video panels. According to embodiments, process 200 includes generating personalized commentary from a single game state. For example, a game event or occurrence may be identified, such as a fight scene or battle, and commentary for the scene or even occurrences in the scene may be used to select player commentary. Selection of the commentary may be based on one or more player perspectives. Accordingly, the game commentary stream may be personalized to one or more players based on the gameplay video data for that player and commentary associated with the player's actions. The personalized commentary may be saved and presented to views to choose between commentary streams. In co-operative and competitive gameplay sessions, custom commentary tracks may be generated to focus on each individual players actions over the course of the session. After the session completes, audio commentary tracks and captured camera perspective for each player can be used for the commentary stream. By providing the commentary stream to for each individual player, a story may be presented from the perspective of each player. The commentary streams may be selected and/or controlled from an interface. In addition, commentary stream tracks can be spliced together as a viewer/spectator provides input to switch player perspective

According to embodiments output of the game commentary stream may be based on a user request received at block 215 for the commentary stream. In some embodiments, the commentary stream may be generated to include game commentary data for a particular user, such as a first user. The user request at block 215 can include a request for recorded game play from the perspective of the first user of the game session and voice data of the first user during the game session. By way of example, the game commentary stream may include commentary by the user and/or commentary selected for the users performance and video of game play based on the user performance. According to other embodiments, a game commentary stream generated at block 210 may be based on a group of players, such a as a team of players. As such, the game commentary stream may be generated to include commentary data from players in the group. According to yet another embodiment, game commentary streams generated at block 210 may be based on events during a session, such that the commentary and game video is selected based on the major events of the game session. By way of example, the game commentary may be a storyline of game events for the game session. At block 215, process 200 can include receiving a user request for the commentary stream to select one or more of a particular user, a group of users (e.g., team) and for game commentary that follows the game storyline.

At block 220, process 200 can include outputting the commentary stream for the game session. Outputting the commentary stream can include output of commentary stream with recorded gameplay video of the game session. Output of the commentary stream includes at least one of user audio and video data. According to embodiments, outputting the commentary stream can include output of audio and video data associated with the first user.

At block 221, process 200 can include receiving a player selection. The player selection may include one or more of an identification or request for a player or character of an electronic game. Process 200 can include receiving a user input for selection of a second user at block 221, and outputting the commentary stream to include output of audio and video data associated with the second user at block 222. Operations at block 221 and 222 may be optional. According to an exemplary embodiment, operations at optional blocks 221 and 22 may be identification of a first player, such as player A, while selection of the section player at block 222 may be an identification of a second player, such as player B. Selection and identification of players may allow a user to obtain a game commentary stream from multiple player perspectives. A viewer viewing the game commentary stream may view the commentary stream for a first period of time following the first player, the game commentary stream may then switch to the second player for a period of time following the first period of time. As such, a viewer can view gameplay, and listen to gameplay commentary of players for the game session. In addition, the player can toggle between one or more players to view the game session from a desired player perspective. According to embodiments, updating selection of a player for presentation of the game commentary stream can include updating gameplay video output. According to embodiments, updating the gameplay data may have the effect of updating a camera view.

FIG. 3 illustrates a graphical representation of a device configuration according to one or more embodiments. Device 300 is configured for generating personalized commentary streams. Device 300 can provide one or more components and functions of control device 105 and/or server 110. Device 300 may represent one or more of a gaming console, computing device and electronic device in general configured to output one or more of video, audio and game data to an output device. Device 300 may provide one or more components of a server or network device.

Device 300 may be a control device or game console device which can include controller 305, memory 315 and input/output (I/O) interface 320. Device 300 may also optionally include game content 310. Controller 305 may relate to a processor or control device configured to execute one or more operations stored in memory 315, such as processes for detecting user socialization preferences and processes for gameplay matchmaking. Memory 315 may be non-transitory memory configured to provide data storage and working memory operations for device 300. Memory 315 may be configured to store computer readable instructions for execution by controller 305 for one or more processes described herein.

Device 300 may be configured to receive gaming media (e.g., card, cartridge, disk, etc.) and output visual and audio content of the gaming media to an output device, such as a display. Device 300 may be configured to provide communication features for users of a game, such as a voice channel, video channel, and/or game chat. Control device 305 may be configured to receive game data streams and player commentary by way of I/O interface 320. Controller 305 may also be configured for synchronizing user commentary to one or more game session events.

Controller 305 may be configured to receive data from one or more other devices such as game consoles and servers (e.g., server 110) to present and output game content. For network games and when device 300 relates to a game console, controller 305 may receive game data from a network source, such as a server, by way of the network and may be configured to control audio features. Controller 305 may be configured to receive input from one or more peripheral devices. When device 300 relates to a server or network device, controller 305 may receive game data from one or more network devices including game consoles and servers by way of the network and may be configured to control audio features and generating of game commentary based on received data.

FIG. 4 illustrates a graphical representation of a process for generating a personalized game commentary stream according to one or more embodiments. Generating a game commentary stream can include receiving game data and game commentary from one or more sources. According to embodiments, process 400 may be performed by a device, such as one or more of control device 105 and/or server 110 to receive game data, such as gameplay data 4051-n, and commentary data, such as user commentary 4101-n, for one or more players of an electronic game. During a game session, for example, user commentary 4101 can include several instances of game commentary 416 detected over a period of time, including game commentary data 416 for at least one user, such as a first user. Similarly, user commentary 4102 can include several instances of game commentary 420 detected over a period of time, including game commentary data 425 for at least one user, such as a second user. Process 400 can include generating a commentary stream 430 for the game session including commentary data for at least one player of the game session. Generating commentary stream 430 can include selection of game commentary data from user commentary 4101-n. Generating commentary stream 430 can include arranging user commentary 4101-n relative to gameplay data 4051-n.

According to embodiments, generating commentary stream 430 includes selection of user commentary 4101-n relative to gameplay data 4051-n such that commentary data 425 is selected from user commentary 4102 and commentary data 416 is selected from user commentary 4102. According to embodiments, commentary data 425 is selected from user commentary 4102 and commentary data 416 is selected from commentary data 4101. Gameplay data 435 is also selected for game commentary stream 430. According to embodiments, at least one of order and presentation time may be controlled for generating the commentary stream. Selection of commentary data may be based on game state of game events. Generation of the game commentary stream 430 may also be based on one or more user perspectives. By way of example, commentary data 425 may relate to a user voice and/or user camera data associated with an event in gameplay data 4051. By way of further example, voice output that is excited or disappointed with respect to a game event. During the game session, a second player may generate commentary data indicating praise or a congratulatory remark for the user associated with game play data 4051, generating the commentary stream may select commentary data 416 and include the commentary data 416 synchronized to the game event. As such, game commentary stream can provide a storyline of player commentary synchronized or placed in association with game events.

According to embodiments, gameplay data 435 of game commentary stream 430 can include gameplay data for one or more users. In addition, gameplay data 435 can include gameplay data from the perspective or one or more users with additional gameplay data added to the commentary stream. According to embodiments, gameplay data 4051 can include one or more video segments or data characterizing gameplay of a first player, such as gameplay data 406. Similarly, gameplay data 4052 can include one or more video segments or data characterizing gameplay of a second player, such as gameplay data 407. Generating commentary stream 430 can include selection of gameplay data to include gameplay data 406 for the first user presenting the perspective of the first user and gameplay data 407 presenting gameplay data for the second user. According to embodiments, generating commentating stream 430 may include generating multiple tracks or storylines, such that gameplay data 435 can be used to provide the gameplay video and commentary from a selected player's perspective.

While this disclosure has been particularly shown and described with references to exemplary embodiments thereof, it will be understood by those skilled in the art that various changes in form and details may be made therein without departing from the scope of the claimed embodiments.

1. A method for generating a personalized game commentary stream, the method comprising:
receiving, by a device, game commentary data from at least one user of a multiplayer electronic game for a game session, wherein the game commentary data includes voice data of the at least one user detected during the game session;
generating, by the device, a commentary stream for the game session, wherein the commentary stream is generated to include gameplay data for the game session and selected game commentary data from the at least one user;
receiving, by the device, a user request for the commentary stream, wherein the request identifies a first user of the game session, and wherein receiving the user request includes receiving a request for recorded game play from the perspective of the first user of the game session and voice data of the first user during the game session; and
outputting, by the device, the commentary stream for the game session based on the user request to include game commentary data for the first user.

2. The method of claim 1, wherein receiving the commentary from the at least one user of the multiplayer game for a game session includes receiving voice data from a plurality of users of the game session and game data for at least one game state of the game session.

3. The method of claim 1, wherein receiving game commentary includes receiving video data of at least one user reaction of the at least one user during the game session.

4. The method of claim 1, wherein generating the commentary stream includes selecting voice data from the at least one user for a game state of the game session, and generating an audio track based on selections of voice data for the game session.

5. The method of claim 1, wherein generating the commentary stream includes selecting voice data from at least one additional user and splicing received voice data for the at least one user and the at least one additional user to generate a commentary stream audio track for the at least one user.

6. The method of claim 1, wherein generating the commentary stream includes selecting voice data to generate an audio track for based on at least one event in the game session.

7. The method of claim 1, wherein the commentary stream for the game session includes one or more of spoken commentary, video reactions, camera data, webcam views, texts and symbols during a game chat.

8. The method of claim 1, wherein outputting the commentary stream includes output of commentary stream with recorded gameplay video of the game session, wherein output of the commentary stream includes at least one of user audio and video data.

9. The method of claim 1, wherein outputting the commentary stream includes output of audio and video data associated with the first user.

10. The method of claim 1, further comprising receiving a user input for selection of a second user, and outputting the commentary stream to include output of audio and video data associated with the second user.

11. A device configured for generating a personalized game commentary stream, the device comprising:
an interface;
a memory storing executable instructions; and
a controller coupled to the interface and the memory, wherein the controller is configured to
receive game commentary data from at least one user of a multiplayer electronic game for a game session, wherein the game commentary data includes voice data of the at least one user detected during the game session;
generate a commentary stream for the game session, wherein the commentary stream is generated to include gameplay data for the game session and selected game commentary data from the at least one user;
receive a user request for the commentary stream, wherein the request identifies a first user of the game session, and wherein receiving the user request includes receiving a request for recorded game play from the perspective of the first user of the game session and voice data of the first user during the game session; and
output the commentary stream for the game session based on the user request to include game commentary data for the first user.

12. The device of claim 11, wherein receiving the commentary from the at least one user of the multiplayer game for a game session includes receiving voice data from a plurality of users of the game session and game data for at least one game state of the game session.

13. The device of claim 11, wherein receiving game commentary includes receiving video data of at least one user reaction of the at least one user during the game session.

14. The device of claim 11, wherein generating the commentary stream includes selecting voice data from the at least one user for a game state of the game session, and generating an audio track based on selections of voice data for the game session.

15. The device of claim 11, wherein generating the commentary stream includes selecting voice data from at least one additional user and splicing received voice data for the at least one user and the at least one additional user to generate a commentary stream audio track for the at least one user.

16. The device of claim 11, wherein generating the commentary stream includes selecting voice data to generate an audio track for based on at least one event in the game session.

17. The device of claim 11, wherein the commentary stream for the game session includes one or more of spoken commentary, video reactions, camera data, webcam views, texts and symbols during a game chat.

18. The device of claim 11, wherein outputting the commentary stream includes output of commentary stream with recorded gameplay video of the game session, wherein output of the commentary stream includes at least one of user audio and video data.

19. The device of claim 11, wherein outputting the commentary stream includes output of audio and video data associated with the first user.

20. The device of claim 11, further comprising receiving a user input for selection of a second user, and outputting the commentary stream to include output of audio and video data associated with the second user.
